(19) United States
(12) Patent Application Publication
(10) Pub. No.: US 2004/0109080 A1
(43) Pub. Date: Jun. 10, 2004

(54) Fixed-focus digital camera with defocus correction and a method thereof

(76) Inventors: Wai San Chan, Bukit Mertajam (MY); Yee Loong Chin, Lahat (MY)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/313,598

(22) Filed: Dec. 5, 2002

(51) Int. Cl. H04N 5/232

(52) U.S. Cl. 348/345

(57) ABSTRACT

A fixed-focus digital camera with defocus correction includes a camera body within which an image sensor is supported. The camera also includes a lens that is supported at an actual distance from the image sensor for focusing an image onto the image sensor. This actual distance is set at least substantially to an optimum distance at which the lens optimally focuses an image on the image sensor. The camera also includes an image processor that accesses and uses preset parameters corresponding to any difference in distance between the optimum distance and the actual distance to process and thereby enhance the visual quality of a captured image. The parameters are obtained during manufacturing of the camera. An image of a calibration object is captured and processed to obtain the parameters. A method of manufacturing the fixed-focus digital camera is also described.

### BACKGROUND

This invention relates to imaging devices. More particularly, this invention relates to a fixed-focus digital camera with defocus correction and a method of manufacturing such a camera

Digital cameras are widely available in the market. These cameras typically include an image sensor, such as a charge-coupled device (CCD) or a complementary metal oxide semiconductor (CMOS) sensor. Each of these cameras further includes a lens, sometimes known as optics, which is spaced apart from the image sensor. For fixed-focus digital cameras, there exists an optimum distance, corresponding to a desired depth of field, between the lens and the image sensor. This optimum distance ensures that images of objects located in the depth of field appear focused on the image sensor. However, due to inaccuracies of parts that are used to support the lens and the image sensor in the camera and other factors such as stack-up errors of the parts, the package type of the image sensor etc., provisions are required during the manufacturing process for adjusting the distance between the lens and the image sensor to the optimum distance. Typically, the parts for supporting the lens and the image sensor are screw-threaded for relative movement therebetween to adjust the distance between the lens and the image sensor. Such screw-threaded parts, especially those of high precision, are expensive to produce.

FIG. 1 shows a prior art sequence of steps for manufacturing such a camera. During manufacturing of the camera, an adhesive is applied on screw threads of the screw-threaded parts. The camera is used to capture an image of a primary calibration object within the depth of field. The image is processed to determine if it is in-focus or out-of-focus. If it is determined that the image is out-of-focus, the distance between the lens and the image sensor is adjusted by moving the screw-threaded parts into a position relative to each other such that the image becomes in-focus. The adhesive is then cured to secure the parts in that position for maintaining the distance between the lens and the image sensor. Some manufacturers view such a process to be tedious, labor-intensive and time-consuming.

### SUMMARY

According to an aspect of the present invention, there is provided a fixed-focus digital camera. The camera includes a camera body within which an image sensor is supported. The camera also includes a lens that is optically oriented towards the image sensor for focusing an image on the image-sensor. The lens is supported at a distance from the image sensor. This distance is being set at least substantially to an optimum distance at which the lens optimally focuses an image on the image sensor. The camera also includes an image processor that accesses and uses preset parameters corresponding to any difference between the optimum distance and the actual distance for processing and thereby enhancing the visual quality of a captured image.

According to another aspect of the present invention, there is provided a method of manufacturing the above-described fixed-focus digital camera. The method includes supporting the lens at an actual distance from the image sensor, the actual distance being at least substantially equal to the optimum distance described above. The method also includes capturing an image of a calibration object that will result in a focused image on the image sensor if the actual distance is equal to the optimum distance. The captured image is processed to obtain parameters corresponding to any difference between the optimum distance and the actual distance. The parameters are stored so that the parameters can be used for processing images captured during use of the camera.

According to yet another aspect of the present invention, there is provided a method of processing an image taken using the fixed-focus digital camera described above. The camera is used to capture the image. Thereafter, the captured image is processed using factory-preset parameters that are obtained as described above to enhance the visual quality of the captured image.

### BRIEF DESCRIPTION OF DRAWINGS

The invention will be better understood with reference to the drawings, in which:

FIG. 1 is flow diagram of a sequence of steps for manufacturing a digital camera according to a prior art embodiment;

FIG. 2 is a sectioned side elevation drawing of a fixed-focus digital camera according to an embodiment of the present invention;

FIG. 3 is a schematic diagram illustrating the major functional blocks of the camera in FIG. 2; and

FIG. 4 is flow diagram of a sequence of steps for manufacturing the camera in FIG. 2 according to another embodiment of the present invention.

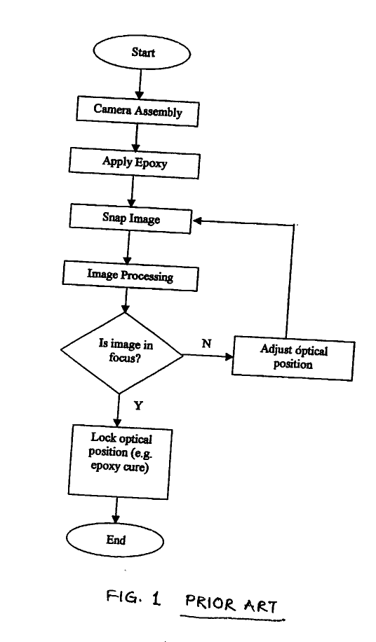

### DETAILED DESCRIPTION

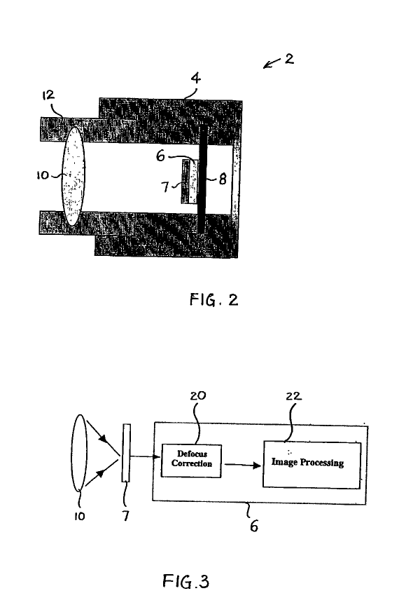

FIG. 2 shows a fixed-focus digital camera 2 according to an embodiment of the present invention. The fixed-focus digital camera 2 includes an opaque camera body 4. Supported within the camera body 4 is an image processing integrated circuit (IC) or image processor 6 mounted on a printed circuit board (PCB) 8. The image processor 6 includes an integrally formed complementary metal oxide semiconductor (CMOS) image sensor 7. The CMOS image sensor 7 may be implemented on an integrated circuit that is separate from the image processor 6. Such a separate image sensor 7 may also be of a charge coupled device (CCD) type. The camera 2 includes a lens 10 that is optically directed towards the image sensor 7 for focusing an image onto the image sensor 7 to produce an image thereon. A support 12 is used to support the lens 10 ideally at an optimum distance from the image sensor 7. Alternatively, the lens 10 and support 12 may be integrally formed. This optimum distance is determined based on many optical parameters including, in particular, a desired depth of field of the camera 2, parameters of the lens 10 and a surface area of the image sensor 7. If the lens 10 could be spaced exactly at such an optimum distance from the image sensor 7, that would allow the lens 10 to optimally focus an image of an object, that is located in the depth of field, onto the image sensor 7.

The support 12 may be attached to the camera body 4 with its position relative to the camera body 4 being adjustable for spacing the lens 10 ideally at a distance equal to the optimum distance away from the image sensor 7 when manufacturing the camera 2. Once the distance between the lens 10 and the image sensor 7 is optimally adjusted, the support 12 is secured to the camera body 4 so as to maintain that distance. That is, once the camera 2 is manufactured, the distance between the lens 10 and the image sensor 7 becomes non-adjustable. The support 12 and the camera body 4 may be suitably screw threaded to allow relative movement therebetween.

Alternatively, the support 12 may be a non-threaded part whose position relative to the camera body 4 is fixed and non-adjustable once assembled on the camera body 4 as shown in FIG. 2. The distance between the lens 10 and the image sensor 7 when supported by such a support 12 is thus non-adjustable. The non-threaded support 12 may have self-gapping features that ideally space the lens 10 at a distance equal to the optimum distance from the image sensor 7 once the support 12 is mounted on the camera body 4. The support 12 may be fixed to the camera body 4, for example, using a snap-fit or by using an adhesive. In both these cases, the distance between the lens 10 and the image sensor 7 is non-adjustable once the support 12 and camera body 4 are snapped or glued together. The support 12 and the camera body 4 may alternatively be integrally formed.

Any inaccuracies in the support 12, the camera body 4, the lens 10 or the image processor 6 for example due to the parts not being manufactured to a high precision or deliberately manufactured with a coarse tolerance may however result in an actual distance between the lens 10 and the image sensor 7 not being equal, but only substantially equal, to the desired optimum distance. Consequently an image of an object, located in the desired depth of field, captured by the image sensor 7 will appear out-of-focus. The out-of-focus image is referred to as a defocus error and is attributed to a difference between the actual lens-image sensor distance and the desired optimum lens-image sensor distance. This difference is sometimes termed an error distance of defocus. The tolerable error distance for a camera is dependent on a desired quality of a captured image.

To enhance the visual quality of such an out-of-focus image, the camera 2 includes factory-preset parameters or matrices that are used for processing the out-of-focus image to numerically correct the image. The method of obtaining these parameters during a manufacturing process of the camera 2 will be described later. These parameters are specific to each individual camera. More accurately, the parameters are specific to or correspond to the error distance of defocus, i.e., the difference between the actual lens-image sensor distance and the desired optimum lens-image sensor distance, of a camera 2. The parameters can be stored on a memory device built into the camera 2, such as an integrated circuit (not shown) readable by the image processor 6 or a memory within the image processor 6. Alternatively, the parameters can be stored on an external media (not shown) separate from the camera 2. The external media may be, but is not limited to, an integrated circuit, a memory card or a card with an appropriate electronic circuitry. When the parameters are stored on an external media, the camera 2 further includes a media reader for receiving the media to read the parameters stored thereon.

The processing of a captured image using the camera 2 is next described with the aid of FIG. 3, which shows major functional blocks of the camera 2. When using the camera 2 to take a picture, the image sensor 7 performs the function of capturing an image of the picture focused thereon by the lens 10 as described previously. The image is stored in digital form in an appropriate memory (not shown). Thereafter, a defocus correction functional block 20 processes the digital form of the captured image. The defocus correction functional block 20 accesses the preset camera-specific parameters and uses them to process the captured image to numerically correct any defocus error to enhance the visual quality of the image. After the captured image has been defocus corrected, an image processing functional block 22 performs one or more image processing functions on the defocus-corrected image. These image processing functions are conventional image processing functions, which include, but are not limited to, auto-exposure and white balance, demosaic, gamma correction, color space conversion and image data compression. The resultant image is then stored onto an external media (not shown). The resultant image may optionally be displayed on a display (not shown) that is connectable to the camera 2.

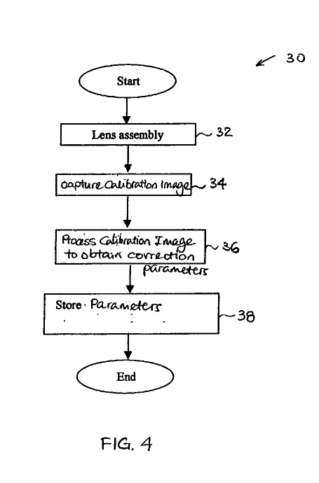

A manufacturing sequence of the camera 2 is next described with the aid of FIG. 4, which shows a sequence 30 of steps. The sequence 30 starts in a LENS ASSEMBLY step 32, wherein the lens 10 is mounted or supported ideally at the optimum distance from the image sensor 7 using the support 12. In the case of the support 12 being of a screw threaded part, adjustment of the screw threaded part is made to keep the distance between the lens 10 and the image sensor 7 as close to the optimum distance as possible. And in the case of the support 12 being a non-threaded part, the support 12 is mounted onto the camera body 4 in an appropriate manner such as by snap-fitting or gluing the support 12 and the camera body 4 together. In both these cases, the distance between the lens 10 and image sensor is fixed once this LENS ASSEMBLY step 32 is completed. There is a possibility that the actual distance between the lens 10 and the image sensor 7 is not optimally set in this step 32 to the optimum distance, resulting in an error distance of defocus. As mentioned previously, the tolerable error distance for a camera is dependent on the desired quality of a captured image.

The sequence 30 next proceeds to a CAPTURE CALIBRATION IMAGE step 34. In this step 34, the lens 10 is used to project light rays reflected off a primary calibration object placed in the depth of field of the camera 2 onto the image sensor 7 to produce a calibration image of the primary calibration object. The calibration image is captured and stored in digital form in an appropriate memory (not shown). The sequence 30 next proceeds to a PROCESS CALIBRATION IMAGE step 36, wherein an image processing means (not shown) processes the calibration image captured by the image sensor 7. The image processing means determines the amount of defocus, i.e. the defocus error, and generates a corresponding set of correction parameters using any known method. As previously described, this set of parameters, corresponding to the defocus error of the particular camera 2, is used to numerically correct images captured during use of the camera 2 to thereby enhance their visual quality. The sequence 30 finally ends in a STORE PARAMETERS step 38, wherein the generated parameters are stored either within the camera 2 or on the external media as described previously. The effectiveness of the set of correction parameters for correcting the defocused calibration image also has a bearing on the tolerable error distance of a camera 2.

The process of manufacturing the camera 2 results in a higher throughput and is less susceptible to yield loss as compared to the prior art. The manufacturing process can be easily automated to make it less labor-intensive. The camera 2 according to the embodiment of the present invention as described above is also low in cost because it does not include high precision parts. The support for the lens and the camera body do not need to include any high precision screw threads or for that matter any screw thread at all. Any error distance of defocus present in the camera is numerically corrected using the preset parameters obtainable during manufacturing.

Although the present invention is described as implemented in the above-described embodiment, it is not to be construed to be limited as such.

We claim:

1. A fixed-focus digital camera comprising:
a camera body;
an image sensor supported within the camera body for capturing an image focused thereon;
a lens optically oriented towards the image sensor and supported by the camera body at an actual distance from the image sensor, the actual distance being set at least substantially to an optimum distance at which the lens optimally focuses an image on the image sensor; and
an image processor that accesses and uses preset parameters corresponding to any difference between the actual distance and the optimum distance for processing and thereby enhancing the visual quality of a captured image.

2. A fixed-focus digital camera according to claim 1, further including a memory device built into the camera for storing the preset parameters.

3. A fixed-focus digital camera according to claim 1, wherein the preset parameters are stored on a media separate from the camera and the camera further includes a media reader for receiving the media and reading the parameters stored thereon.

4. A fixed-focus digital camera according to claim 1, wherein the actual distance between the lens and the image sensor is non-adjustable once the camera is manufactured.

5. A fixed-focus digital camera according to claim 4, further including:
a support for supporting the lens, wherein the support is mounted to the camera body such that the position of the support relative to the camera body is non-adjustable once the support is mounted to the camera body.

6. A fixed-focus digital camera according to claim 5, wherein the lens and the support are integrally formed.

7. A fixed-focus digital camera according to claim 5, wherein the support and the camera body are fixed to each other via a snap-fit.

8. A fixed-focus digital camera according to claim 1, wherein the image sensor is integrally formed with the image processor.

9. A fixed-focus digital camera according to claim 8, wherein the image sensor is a CMOS sensor.

10. A method of manufacturing a fixed-focus digital camera having an image sensor and a lens optically oriented towards the image sensor, the method comprising:
supporting the lens at an actual distance from the image sensor, the actual distance being at least substantially equal to an optimum distance at which the lens optimally focuses an image on the image sensor;
capturing an image of a calibration object that would result in a focused image on the image sensor if the actual distance is equal to the optimum distance;
processing the captured image to obtain parameters corresponding to any difference between the actual distance and the optimum distance; and
storing the parameters so that the parameters can be used for processing images captured during use of the camera.

11. A method of manufacturing a fixed-focus digital camera according to claim 10, wherein storing the parameters includes storing the parameters in a memory device built into the camera.

12. A method of manufacturing a fixed-focus digital camera according to claim 10, wherein storing the parameters includes storing the parameters in a media separate from and readable by the camera.

13. A method of processing an image taken by a fixed-focus digital camera having an image sensor and a lens fixedly supported at an actual distance from the image sensor, the method comprising:
capturing the image by the camera; and
processing the captured image using factory-preset parameters corresponding to any difference between the actual distance and an optimum distance at which the lens optimally focuses an image on the image sensor to enhance the visual quality of the captured image.
